(19) United States
(12) Patent Application Publication
(10) Pub. No.: US 2012/0174428 A1
(43) Pub. Date: Jul. 12, 2012

(54) PRE-PRINTED NEWSPRINT SHEETS FOR DRYING SHOES

(76) Inventors: DAMIAN HARTNER, NEW YORK, NY (US); BRIAN HARTNER, NEW YORK, NY (US)

(21) Appl. No.: 13/004,886

(22) Filed: Jan. 12, 2011

(51) Int. Cl. F26B 3/00; F26B 13/26; B42D 15/00

(52) U.S. Cl. 34/353; 283/56; 34/95

(57) ABSTRACT

A method for drying shoes comprising the steps of: providing a pair of wet shoes with insole; utilizing a plurality of newsprint sheets; crumpling up the newsprint sheets; stuffing the crumpled newsprint sheets into the wet shoes; setting the wet shoes aside for a specific amount of time, so that the crumpled newsprint sheets will absorb the moisture from within the wet shoes; removing the wet crumpled newsprint sheets out of the dry shoes; and disposing the wet crumpled newsprint sheets in a proper manner.

### CROSS-REFERENCE TO RELATED APPLICATION

This application claims the benefit of Provisional Patent Application No. 61/293,736, filed on Jan. 11, 2010, in the United States Patent & Trademark Office, the disclosure of which is incorporated herein by reference.

### BACKGROUND OF THE INVENTION

1. Field of the Invention

The present invention relates to footwear moisture removing systems, and more particularly, a method for drying shoes.

The present invention provides a quick and efficient method of drying out a pair of wet shoes with insoles. The method is ideal for absorbing water or sweat from athletic shoes. It allows athletes to dry their shoes using pre-printed newsprint sheets that contain advertisements and coupons. The newsprint sheets can be viewed and then crumpled and placed inside the shoes to draw out the moisture. The present invention offers a fast and easy way to dry wet shoes with insoles.

2. Description of the Prior Art

Many athletes often find themselves wearing wet shoes. This may be because they were exercising in the rain or their feet have perspired in the shoes. Regardless, it is necessary to dry out the shoes so that they do not become moldy or odorous. A wide variety of methods and devices have been tried to dry the wet shoes without damaging them. The absorbing insoles can not handle the excess wetness. Normally, the wet moisture for each shoe is more than one ounce of water. Paper towel is normally not available for everybody in the running events. Air drying of wet shoes is slow, and can lead to undesirable odors in the shoes. To accelerate drying time, people have been known to place wet shoes near a heat source, such as a fireplace or stove, whereby the shoes becomes subject to hot spots, burned and scorched heels and soles, and shrinking. A wide variety of devices are attached to hair dryers or have various combinations of electric heaters, flexible air hoses and electric blowers are known to dry shoes. For convenience, many people choose to dry shoes in automatic clothes dryers, however, in doing so they can experience a problem. Placing the shoes in the dryer can ruin the rubber on the bottom of the shoes. A more efficient method is needed. Numerous innovations for shoe identification devices have been provided in the prior art that will be described. Even though these innovations may be suitable for the specific individual purposes to which they address, however, they differ from the present invention.

A FIRST EXAMPLE, U.S. Patent Office Publication No. 2004/0261294, Published on Dec. 30, 2004, to Kawata teaches insoles for shoes in which the insoles each have an insole body with the surface thereof made of paper or non-woven cloth, and onto the surface of this insole body is adhered a transparent or semitransparent synthetic resin sheet carrying designs such as pictures and characters on a rear surface thereof. With this configuration, the insoles become much more fashionable as compared to the conventional ones, are not mistaken for other's shoes even at a place where there are a number of pairs of shoes of the same type, allow a user to find his or her own pair of shoes at a glance, and give him or her the pleasure when wearing the same.

A SECOND EXAMPLE, U.S. Patent Office Publication No. 2005/0241186, Published on Nov. 3, 2005, to Mulligan et al. teaches a printed film innersole (PFI) and a process for making the same. The present invention provides to a PFI and a process for the construction of an innersole for post-insertion into a shoe that can have significant design details added to the bottom surfaces.

A THIRD EXAMPLE, U.S. Pat. No. 7,325,335, Issued on Feb. 5, 2008, to Cook-Ewell teaches a message-bearing apparatus or method of communicating a message for footwear and, in particular, to a color/pattern/picture coordinated message bearing method for wear inside footwear that carries a preprinted inspirational message on one side of the apparatus as well as a picture relating to the message in the background of the same side with the text.

A FOURTH EXAMPLE, U.S. Patent Office Publication No. 2008/0073229, Published on Mar. 27, 2008, to Hays teaches an insole for a shoe providing information fields for identifying the wearer of the shoe. The insole may have pre-printed information fields providing spaces for a person to provide information identifying the wearer of the shoe, as well as pertinent medical and contact information. The insole is provided in a preselected shape and size so that it removably and snugly fits within a shoe of a given standard shoe size. In one embodiment, design features may be added to the insole. A package containing one or more insoles with such information fields may also be provided, and may have a label indicating the standard shoe size corresponding to the size and shape of the insole.

A FIFTH EXAMPLE, U.S. Patent Office Publication No. 2009/0077718, Published on Mar. 26, 2009, to Hampton teaches a therapeutic device, manifest as an improvement to footwear generally. The improvement is the inclusion/affixing of a visual reference, for the purpose of suppressing the energy of that to which is referred.

It is apparent now that numerous innovations for shoe identification devices have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a method for drying shoes that avoids the disadvantages of the prior art.

ANOTHER OBJECT of the present invention is to provide a method for drying shoes that is simple and inexpensive to manufacture.

STILL ANOTHER OBJECT of the present invention is to provide a method for drying shoes that is simple to use.

BRIEFLY STATED, STILL YET ANOTHER OBJECT of the present invention is to provide a method for drying shoes comprising the steps of: providing a pair of wet shoes with insoles; utilizing a plurality of newsprint sheets; crumpling up the newsprint sheets; stuffing the crumpled newsprint sheets into the wet shoes with insole; setting the wet shoes aside for a specific amount of time, so that the crumpled newsprint sheets will absorb the moisture from within the wet shoes; removing the wet crumpled newsprint sheets out of the dry shoes; and disposing the wet crumpled newsprint sheets in a proper manner.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a perspective view showing a wet shoe and a newsprint sheet next to it;

FIG. 2 is a perspective view showing a plurality of newsprint sheets having different advertisements and coupons;

FIG. 3 is a perspective view showing a newsprint sheet being crumpled;

FIG. 4 is a perspective view showing the crumpled newsprint sheet being inserted into the wet shoe; and

FIG. 5 is a perspective view showing the wet crumpled newsprint sheet removed from the dry shoe.

### REFERENCE NUMERALS UTILIZED IN THE DRAWING

110 shoe
112 newsprint sheet
114 newsprint on newsprint sheet 112
116 advertisements for newsprint 114
118 coupons for newsprint 114
120 person
122 non-glossy paper material for newsprint sheet 112

### DETAILED DESCRIPTION OF THE PREFERRED EMBODIMENT

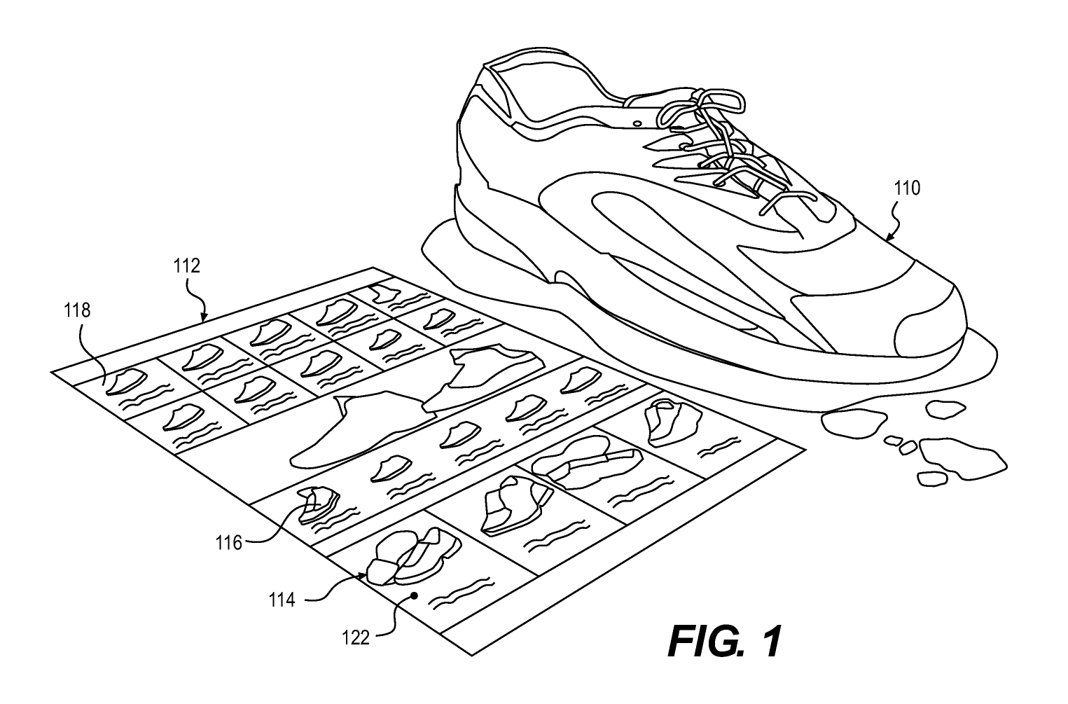

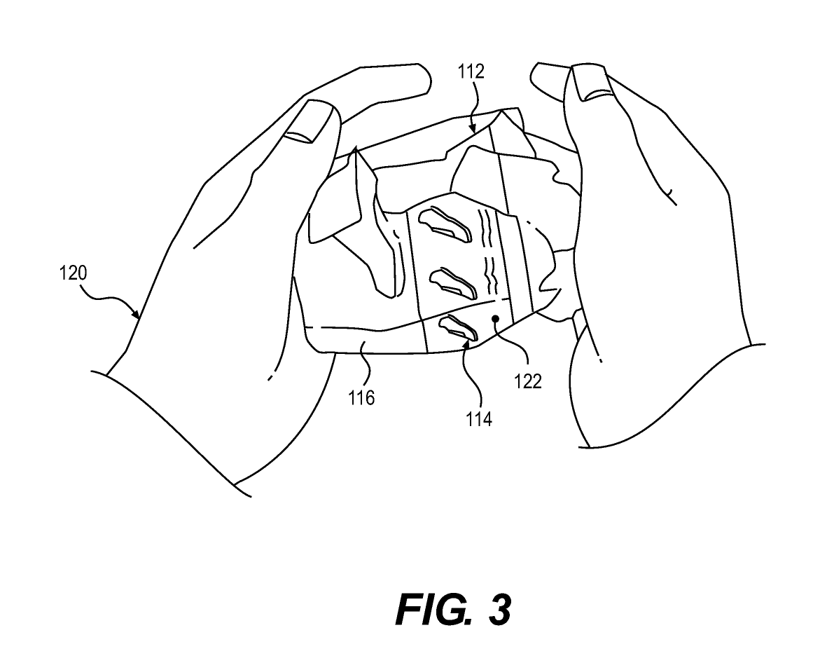

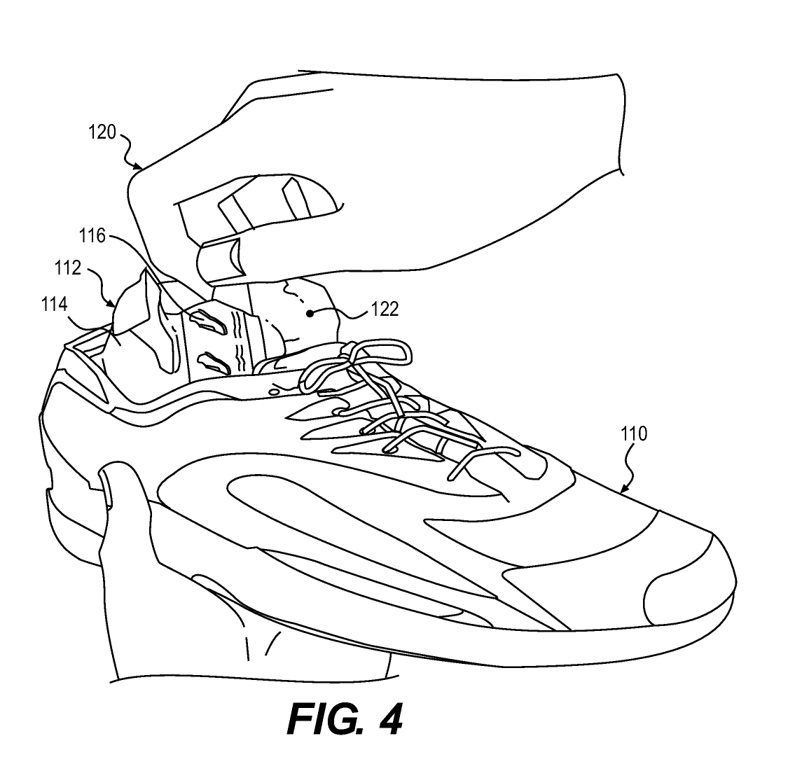

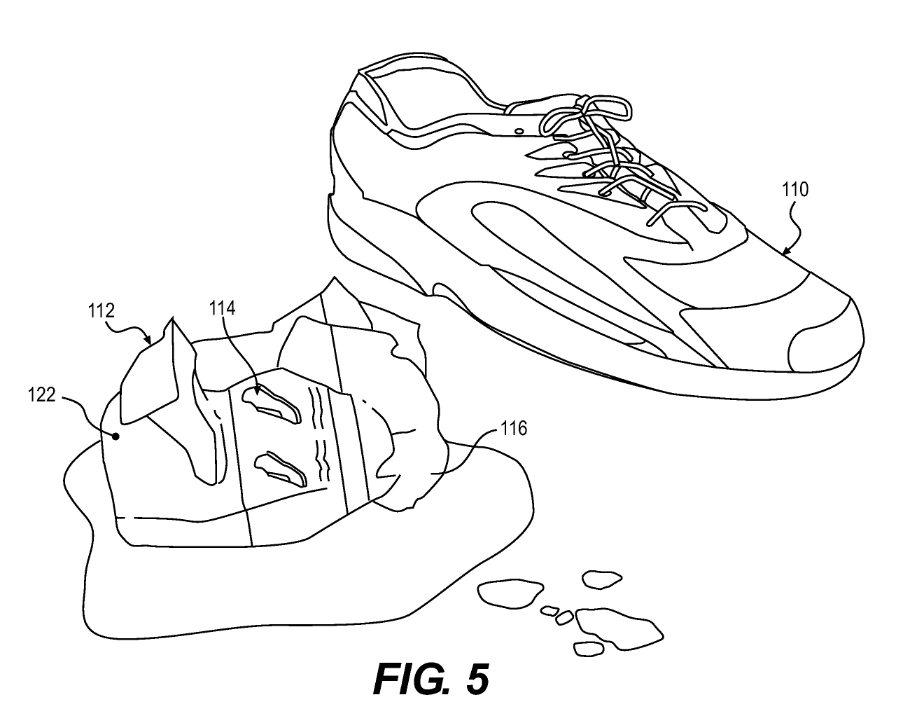

Referring now to the figures, in which like numerals indicate like parts, and particularly to FIGS. 1 through 5, and as such, will be discussed with reference thereto.

The present invention, shown in FIG. 1 through 5 is a method for drying shoes 110 comprising the steps of: providing a pair of wet shoes 110 with insoles; utilizing a plurality of newsprint sheets 112; crumpling up the newsprint sheets 112; stuffing the crumpled newsprint sheets 112 into the wet shoes 110 with insoles; setting the wet shoes 110 aside for a specific amount of time, so that the crumpled newsprint sheets 112 will absorb the moisture from within the wet shoes 110; removing the wet crumpled newsprint sheets 112 out of the dry shoes 110; and disposing the wet crumpled newsprint sheets 112 in a proper manner.

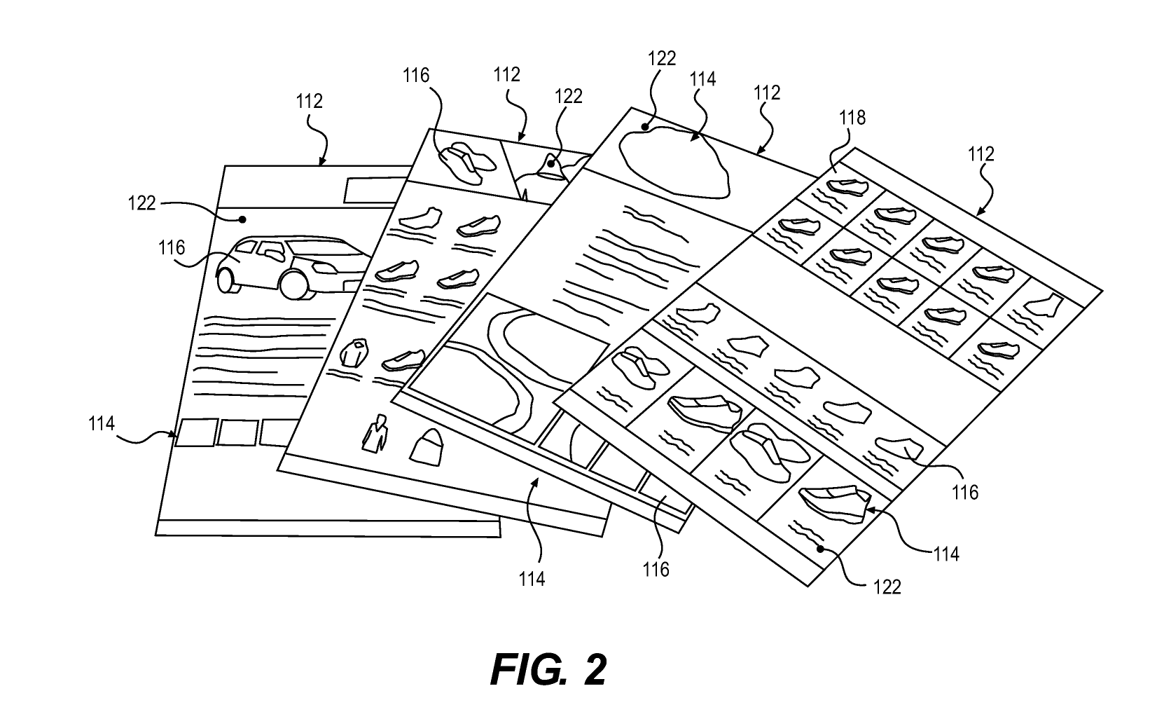

As best shown in FIGS. 1 and 2, the newsprint sheets 112 contain newsprint 114 having advertisements 116 and coupons 118 that cater to a specific audience (e.g. runners, . . . ). There are perforated or dotted lines to separate the news, coupons and advertisements. A person 120 can view the newsprint 114 on the newsprint sheets 112 before the newsprint sheets 112 are crumpled up and used to dry out the shoes 112. Each newsprint sheet 112 measures approximately twenty four (24) inches by twenty one (21) inches (24×21 inches). The ink is insoluble so the newsprint 114 does not smear the ink into the shoes 110. Each newsprint sheet 112 is comprised out of a non-glossy paper material 122 making the newsprint sheet 112 more absorbent. For absorbing one ounce of excess wet water, we need two sheets. We can use more sheets 112 if the shoes 110 are still wet.

In summary, the present invention is an effective method of drying out a pair of shoes 110. It also offers a way to reach a target audience with newsprint sheet 112 having a newsprint 114 being advertisements 116 and coupons 118. Each newsprint sheet 112 measures approximately twenty four inches by twenty one inches. The newsprint 116 on the newsprint sheets 112 contain the advertisements 116 and the coupons 118 that caters to a specific audience. A person 120 can view the newsprint 116 and then crumple the newsprint sheets 112 and place them on the top of the insoles of their wet shoes 110. The newsprint sheets 112 will absorb the extra moisture in the shoes 110. After use, the newsprint sheets 112 may be disposed of. Each newsprint sheet 112 is made out of a non-glossy paper material 122 with insoluble ink (e.g. hot-melt ink, . . . ). A wide variety of restaurants, shoe companies, and the like can advertise on the newsprint sheets 112. The printing of the newsprint 114 may be done in a variety of colors. The exact specifications may vary.

It will be understood that each of the elements described above, or two or more together, may also find a useful application in other types of constructions differing from the types described above.

While the invention has been illustrated and described as embodiments of a method for drying shoes, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A method for drying shoes in a running event which comprises the steps of:
a) providing a pair of wet shoes with insole;
b) utilizing a plurality of newsprint sheets relating to the running event;
c) crumpling up the newsprint sheets;
d) stuffing the crumpled newsprint sheets onto the top of the insole of the wet shoes;
e) setting the wet shoes aside for a specific amount of time, so that the crumpled newsprint sheets will absorb the moisture from within the wet shoes;
f) removing the wet crumpled newsprint sheets out of the dry shoes; and
g) disposing the wet crumpled newsprint sheets in a proper manner.

2. The method as recited in claim 1, wherein the newsprint sheets contain newsprint having advertisements, news and coupons that cater to the running event, whereby a person can view the newsprint on the sheets before the newsprint sheets are crumpled up and used to dry out the excess wet water of the shoes.

3. The method as recited in claim 1, wherein each newsprint sheet measures approximately twenty four inches by twenty one inches and each sheet is for absorbing one ounce of excess wet water.

4. The method as recited in claim 1, wherein each newsprint sheet is comprised out of a non-glossy paper material making the newsprint sheet more absorbent and is printed with insoluble ink such as hot-melt ink.

5. A pre-printed newsprint sheets for drying shoes with absorbing insoles in a running event comprising of:
Non-glossy paper sheets in the rectangular size 24 inches×21 inches; wherein each sheet can absorb one ounce of excess wet water inside the shoes and each sheet is inserted onto the top of the absorbing insoles inside of the shoes during the running event;
Pre-printed advertisements, coupons and news related to the running event are printed in different sections of the sheets and the sections are separated by perforated lines; and
Insoluble ink is used to pre-print the advertisements, coupons, and news so the ink would not smear into the shoes.

6. A pre-printed newsprint sheers for drying shoes with absorbing insoles further comprising insoluble hot-melt ink for the newsprint, coupons, and advertisements.
